(19) United States
(12) Patent Application Publication
(10) Pub. No.: US 2007/0149013 A1
(43) Pub. Date: Jun. 28, 2007

(54) Electrical outlets and plugs with local power enabling and disabling

(76) Inventors: Bryant Eastham, Draper, UT (US); Mark E. Nelson, Lindon, UT (US)

Correspondence Address: MADSON & AUSTIN;GATEWAY TOWER WEST, SUITE 900, 15 WEST SOUTH TEMPLE, SALT LAKE CITY, UT, 84101, US

(21) Appl. No.: 11/316,420

(22) Filed: Dec. 22, 2005

(51) Int. Cl. H01R 13/44

(52) U.S. Cl. 439/140

(57) ABSTRACT

Improved electrical outlets and plugs that allow local power enabling and disabling are disclosed. One embodiment of an electrical outlet device includes a power socket capable of receiving a plug and a switch that is in electrical communication with a power supply wire. When the switch is in a first position, no power is available at the power socket. When the switch is in a second position, power is available at the power socket. The electrical outlet device also includes a sensor that is capable of detecting a signal from the plug. The plug includes a signal producing element. The sensor is in electrical communication with the switch such that when the sensor detects the signal from the plug, the sensor causes the switch to be in the second position thereby providing power at the power socket.

### TECHNICAL FIELD

The present invention relates generally to electrical technology. More specifically, the present invention relates to improved electrical outlets and plugs with local power enabling and disabling.

### BACKGROUND

Most homes include at least one electrical outlet that provides the electricity necessary to operate household appliances, television sets, computers, etc. The standard electrical outlet in the United States includes two vertical slots and a round hole centered below these two slots. The left vertical slot is the “neutral” slot and is slightly larger than the right vertical slot which is the “hot” slot. The hole below the two slots is designated as “ground.”

Each of these electrical outlets is connected to the home's circuit breaker by a wire. The circuit breaker is a safety feature that cuts off the power supply to the electrical outlet when the current flow rises above a certain threshold. For example, if a wire is placed in the hot slot and the neutral slot, there would be a tremendous amount of current flowing through the wire. The circuit breaker would detect this surge and cut off the power supply to the electrical outlet in order to prevent a fire or other harmful effects. However, until the flow of current passes this threshold, the electrical outlet has a constant supply of power.

The electricity provided at the electrical outlet does not begin to flow until there is a completed connection from the hot slot to the neutral slot. For example, when a household appliance, such as a vacuum, is plugged into the electrical outlet, the connection is completed. The electricity flows from the hot slot, through the vacuum to run the motor, and back to the neutral slot. A further example may include a light bulb that is plugged into the outlet. The electricity will flow from the hot slot, through the filament, and back to the neutral slot, creating light in the process.

Almost all parents of young children have at some point worried about their child's safety around electrical outlets in the home. The outlets are usually installed at a height at or near a child's eye level, and a child's curiosity draws them to explore. A child may insert an object into the slots of the outlet and complete the connection between the hot slot and the neutral slot. Electricity may then flow through the child. The results of electrocution from these electrical outlets can be fatal. Many of the home electrocution and shock injuries involve unsupervised children. There are a few protective measures currently available in the art that can be taken to avoid injury or death to a child.

The most common protective measure is a plastic outlet protector. The plastic protector includes two prongs that fit directly into the outlet slots, preventing the insertion of foreign objects. However, these plastic plug inserts are inconvenient for several reasons. They are hard to put in and pull out (by design). When someone wants to plug something into the electrical outlet they typically leave the plug insert lying around somewhere close to the outlet, like on the floor nearby, where it now turns into a choking hazard. The plastic inserts are also easy to misplace. Some toddler age children may also discover how to remove these plastic protectors themselves.

Based upon the current disadvantages and problems with the protective measures currently available in the art, it would be beneficial if improvements were made to provide safety and to provide enhanced control of electrical outlets. Specifically, it would be beneficial to only provide power to the electrical outlets under desirable circumstances.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 is an illustration of an embodiment of an electrical plug and receptacle designed for locally enabling and disabling power to the power sockets of the receptacle;

FIG. 2 is a cross-sectional block diagram of an embodiment of an electrical plug and receptacle designed for locally enabling/disabling the socket of the receptacle with power;

FIG. 3 is a cross-sectional block diagram of an embodiment of an electrical plug and receptacle using a magnet and a reed switch;

FIG. 4 is a cross-sectional block diagram of an embodiment of an electrical plug and receptacle using an RFID (Radio Frequency Identification) tag and an RFID reader or RFID sensor;

FIG. 5 is a cross-sectional block diagram of an embodiment of an electrical plug and receptacle using a mechanical finger;

FIG. 6 is an illustration of a plug adapter;

FIG. 7 is an illustration of another embodiment of a plug adapter;

FIG. 8 is a block diagram illustrating a lighting system that may utilize the systems and methods disclosed herein;

FIG. 9 is a block diagram illustrating a security system that may utilize the systems and methods disclosed herein; and

FIG. 10 is a block diagram illustrating a home system that may utilize the systems and methods disclosed herein.

### DETAILED DESCRIPTION

One embodiment of an electrical outlet device includes a power socket capable of receiving a plug and a switch that is in electrical communication with a power supply wire. When the switch is in a first position, no power is available at the power socket. When the switch is in a second position, power is available at the power socket. The electrical outlet device also includes a sensor that is capable of detecting a signal from the plug. The plug includes a signal producing element. When the sensor detects the signal from the plug, the sensor causes the switch to be in the second position thereby providing power at the power socket. When the sensor does not detect the signal from the plug, the sensor causes the switch to be in the first position thereby providing no power at the power socket.

The sensor and/or the switch may be implemented in various ways. The sensor and the switch may comprise a reed switch. Alternatively, the sensor may include an RFID reader. Furthermore, the sensor may comprise a mechanical sensor capable of detecting a physical element of the plug. For example, the mechanical sensor may include a channel that mates with a finger of the plug.

An electrical plug is also disclosed that includes one or more contacts for connecting to a power socket and a signal producing element that produces a signal to be used in combination with an electrical outlet device having a switch and a sensor. The sensor in the electrical outlet device is in electrical communication with the switch in the electrical outlet device such that when the sensor detects the signal from the plug, the sensor causes the switch to be in a second position thereby providing power at the power socket. When the sensor does not detect the signal from the plug, the sensor causes the switch to be in a first position thereby providing no power at the power socket.

An electrical plug adapter is disclosed that includes one or more holes for receiving one or more contacts from a plug such that the contacts go through the holes with sufficient depth that the contacts may be inserted into a power socket of an electrical outlet device having a switch and a sensor. The electrical plug adapter includes a signal producing element that produces a signal to be used in combination with the electrical outlet device. The sensor in the electrical outlet device is in electrical communication with the switch in the electrical outlet device such that when the sensor detects the signal from the plug adapter, the sensor causes the switch to be in a second position thereby providing power at the power socket. When the sensor does not detect the signal from the plug adapter, the sensor causes the switch to be in a first position thereby providing no power at the power socket.

The signal producing element of the plug adapter may include a magnet to be used in combination with a reed switch in the electrical outlet device. Alternatively the signal producing element of the plug adapter may include an RFID tag to be used in combination with an RFID reader in the electrical outlet device.

Another electrical plug adapter is disclosed that includes one or more holes for receiving an electrical plug to enable the electrical plug to be plugged into the electrical plug adapter. The electrical plug adapter also includes one or more contacts that are configured to be inserted into a power socket of an electrical outlet device having a switch and a sensor. The electrical plug adapter includes a signal producing element that produces a signal to be used in combination with the electrical outlet device. The sensor in the electrical outlet device is in electrical communication with the switch in the electrical outlet device such that when the sensor detects the signal from the plug adapter, the sensor causes the switch to be in a second position thereby providing power at the power socket. When the sensor does not detect the signal from the plug adapter, the sensor causes the switch to be in a first position thereby providing no power at the power socket.

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

Most people are familiar with the child-proof plug inserts that protect children from sticking things in electrical outlets. These child-proof plug inserts are inconvenient for several reasons. They are hard to put in and pull out (by design). When someone wants to plug something into the wall outlet they typically leave the plug insert lying around somewhere close to the outlet, like on the floor nearby, where it now turns into a choking hazard. The child-proof inserts are also easy to misplace. It would be beneficial if improvements were made to provide safety and to provide enhanced control of wall outlets.

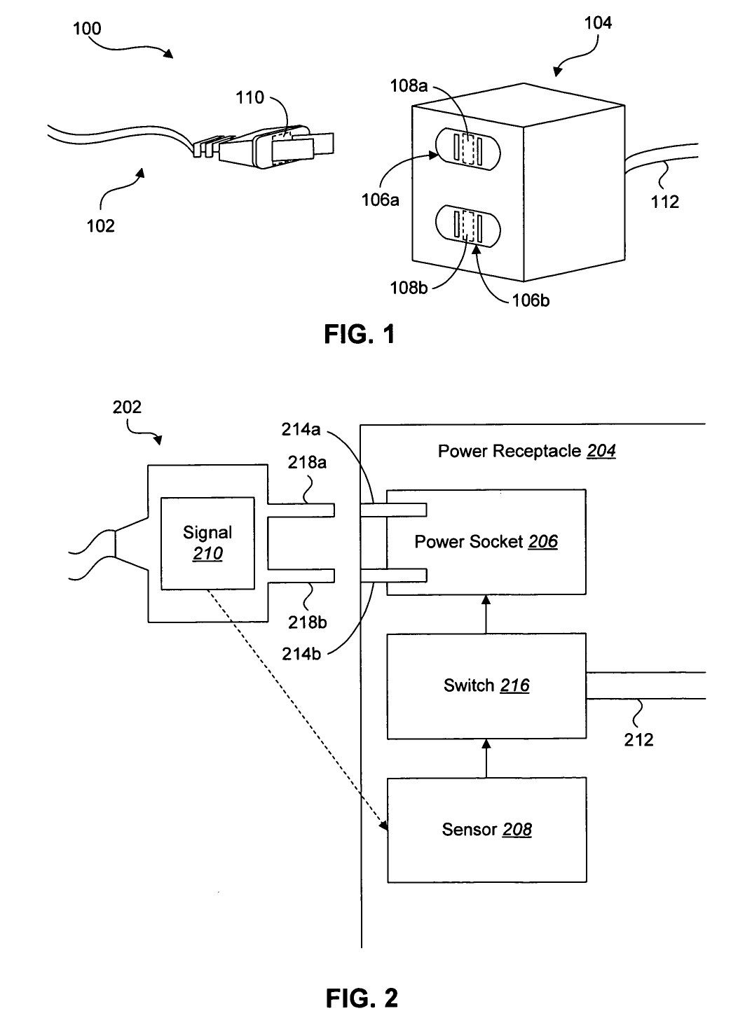

FIG. 1 is an illustration of an embodiment 100 of an electrical plug 102 and receptacle 104 designed for locally enabling and disabling power to the power sockets 106a, 106b of the receptacle 104. One or more sensors 108a, 108b in the receptacle 104 are paired with a signal producing element 110 embedded in the plug 102. The sensors 108a, 108b need to be activated in order for the power sockets 106a, 106b to receive any power from the receptacle 104, also known as an outlet 104. The sensors 108a, 108b are used as input to control a switch or relay in the outlet 104. Although the receptacle 104 in FIG. 1 is shown with two power sockets 106a, 106b and two sensors 108a, 108b, different configurations are contemplated. For example, the receptacle 104 may have two power sockets and only one sensor that activates both sockets. Furthermore, the receptacle 104 may only have one power socket and one sensor. It is also possible that the receptacle 104 may have two power sockets 106a, 106b and two sensors 108a, 108b (similar to FIG. 1) wherein either sensor 108a, 108b may activate both power sockets 106a, 106b. Thus, the embodiments disclosed herein are only examples and are not meant to limit the scope of the present invention.

An electrical receptacle 104, sometimes referred to as an outlet 104, is shown with two power sockets 106a, 106b. A wire 112 supplies electricity to the receptacle 104 and will lead back to a circuit breaker (not shown). The electrical receptacle 104 includes at least one sensor 108 for determining whether power should be enabled to the sockets 106, as described.

The plug 102 is shown proximate to the electrical receptacle 104. The plug 102, when plugged in and when the socket 106 is enabled to provide power, will provide power to the appliance or device (not shown) to which it is connected. The plug 102 includes a signal producing element 110 of some kind that is paired with one or more sensors 106 so that when the signal (from the signal producing element 110) is present one or more sensors 106 will detect the signal and enable one or more power sockets 106 with power. Several different kinds of sensor/signal pairs may be used, as will be discussed below. In operation, no power is available at the socket 106 unless a suitable plug 102 is inserted or is proximate to the receptacle 104 and the desired signal is sensed.

FIG. 2 is a block diagram of an embodiment 200 of an electrical plug 202 and receptacle 204 designed for locally enabling/disabling the socket 206 of the receptacle 204 with power. The electrical receptacle 204 or wall outlet 204 shown in FIG. 2 includes one socket 206, the power socket 206. The power socket 206 is configured to mate with the plug 202, as is known in the art, to provide power to the plug 202. In this example the power socket 206 includes two slots 214a, 214b for the plug 202.

The electrical receptacle 204 includes a switch 216. The electricity supply wire 212 provides power. The switch 216 operates to provide power to the power socket 206 or turn the power off to the power socket 206, depending on the sensor's 208 reading. In some embodiments a relay may be used.

The electrical receptacle 204 includes a sensor 208 for determining whether power should be enabled to the socket 206 or not. The sensor 208 detects the signal from the plug 202, or detects the signal from the signal producing element 210 in the plug 202, and turns the power on to the power socket 206 when the signal is present. When the signal is not present, the sensor 208 causes the switch 216 to turn off the power to the power socket 206.

A plug 202 is shown proximate to the electrical receptacle 204. The plug 202 includes two contacts 218a, 218b. The contacts 218a, 218b mate with the slots 214a, 214b as is known in the art. The plug 202 includes a signal producing element 210, as discussed.

Different kinds of plugs and sockets may be used with the embodiments herein. Although the embodiments herein illustrate an American 2-pin plug, other kinds of plugs may be used including, but not limited to, an American 3-pin, a European 2-pin, an old British 3-pin, a French 2-pin, a German 2-pin, an Israeli 2-pin, etc. Any kind of plug/socket may be used to implement the embodiments illustrated herein.

Different kinds of sensor/signal pairs may be used. Several specific examples will be discussed below. However, additional sensor/signal pairs may also be used.

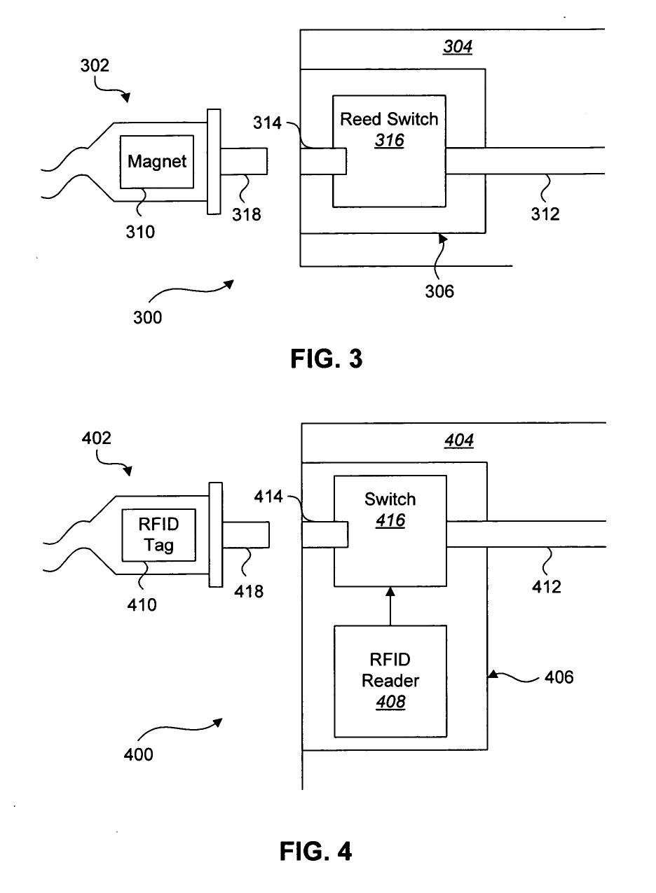

FIG. 3 is a cross-sectional block diagram of an embodiment 300 of an electrical plug 302 and receptacle 304 using a magnet 310 and a reed switch 316. The electrical receptacle 304 or wall outlet 304 shown in FIG. 3 includes one socket 306, the power socket 306. The power socket 306 includes a reed switch 316 which is opened or closed thereby turning power on and off to the power socket 306. The electricity supply wire 312 provides power.

The plug 302 is shown proximate to the electrical receptacle 304. The plug 302 includes two contacts 318. The plug 302 includes a magnet 310 which, when close to the reed switch 316, will activate to enable power to the power socket 306. When the magnet 310 is not close to the reed switch 316, the switch 316 will disable power to the power socket 306.

FIG. 4 is a cross-sectional block diagram of an embodiment 400 of an electrical plug 402 and receptacle 404 using an RFID (Radio Frequency Identification) tag 410 and an RFID reader 408 or RFID sensor 408. The power socket 406 includes an RFID reader 408 that will open or close the switch 416 thereby turning power on and off to the power socket 406. The RFID reader 408 detects the presence of an RFID tag 410 in the plug 402. Thus, when the plug 402 is present, power will be enabled to the socket 406. When the plug 402 is not present, power will be disabled to the socket 406.

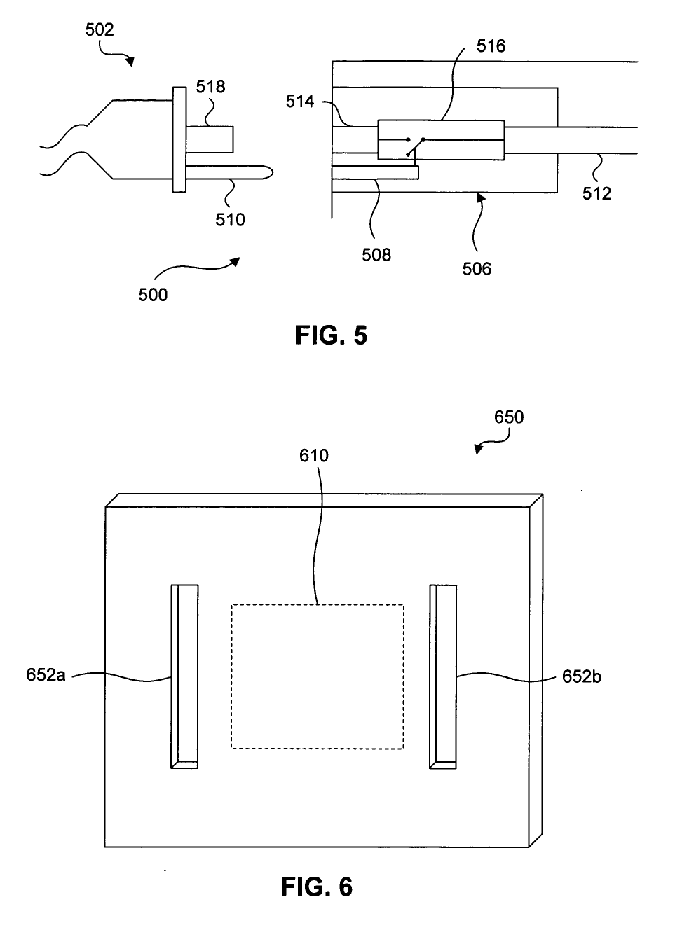

A mechanical solution where the sensor is a switch and the signal is a physical part of the plug that affects the switch may be used. A mechanical solution may be less secure because a child can mimic the physical part of the plug. FIG. 5 is a cross-sectional block diagram of an embodiment 500 of an electrical plug 502 and receptacle 504 using a mechanical finger 510. The power socket 506 includes a channel 508 that mates with the finger 510 on the plug 502. When the finger 510 is inserted into the channel 508, a mechanical switch 516 is turned on to enable power to the power socket 506. When the finger 510 is not in the channel 508, the mechanical switch 516 is turned off and no power is supplied to the power socket 506. In one embodiment one or both prongs 518 act as the finger in addition to their normal function.

With the aforementioned examples, manufacturers would construct the signal producing element 110 into their plugs 102 (e.g., a magnet, an RFID chip, etc.). However, there will be a number of plugs that were not manufactured with these signals/signal producing elements 110. The older plugs would not enable power at the socket unless they were enhanced in some way. The following embodiment provides a way to enhance existing plugs to work with the present embodiments.

FIG. 6 is an illustration of a plug adapter 650. The plug adapter 650 is thin enough such that it can be placed onto an existing plug but still allow the plug to be inserted into the slots of the socket 106. The adapter 650 includes holes 652a, 652b to allow the existing contacts of a plug (not shown in FIG. 6) to pass therethrough. The adapter 650 has the signal producing element 610. When the adapter 650 is placed onto a plug 102, the plug 102 will operate to activate/deactivate the power at the socket 106 as desired.

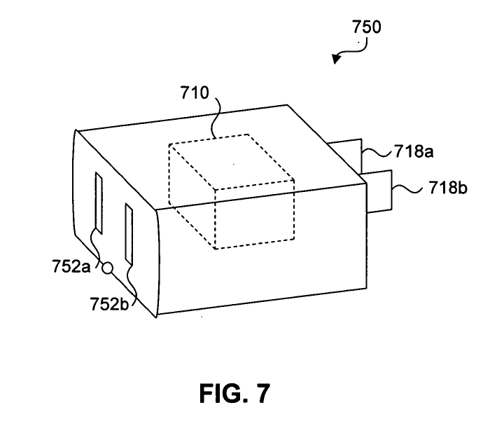

FIG. 7 is an illustration of another embodiment of a plug adapter 750. The plug adapter 750 in FIG. 7 is a socket in itself in which the plug 102 is inserted. The plug adapter 750 includes its own contacts 718a, 718b as well as a signal producing element 710. A plug 102 that needed to be enhanced is simply plugged into this adapter 750, which is in turn plugged into the power socket 106 for power.

The embodiments disclosed herein may be used in many different ways. For example, home owners may decide to only require the special signal on plugs that are installed near the floor. With this kind of use, it is assumed that plugs near the floor will be accessible by small children, but that plugs up higher are typically only used by adults.

With the present embodiments, it is also possible to design a global enable or disable for the entire home or premises. For example, when children grow up a parent may turn these switches off. The parents may globally turn them back on when, by way of example, grandchildren visit. It is also possible to enable the feature for certain rooms in the home. It would also be possible to use a voice signal to enable the power: “turn on the power” said after plugging something in would enable it.

The present systems may be used in several contexts. The improved plugs and receptacles may be used virtually anywhere where power is needed. Thus, the applications for the presents systems, and methods for using them, are numerous. Three different contexts and environments in which the disclosed plugs and receptacles may be used will be discussed below.

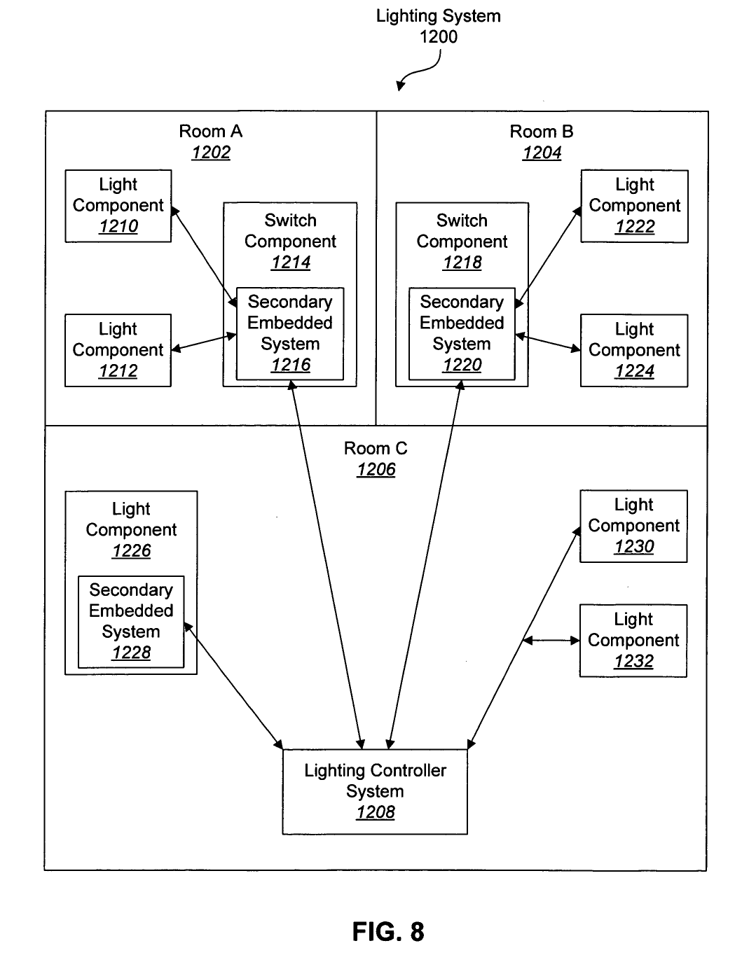

FIG. 8 illustrates one embodiment of a system wherein the present systems and methods may be implemented. FIG. 8 is a block diagram that illustrates one embodiment of a lighting system 1200 that includes a lighting controller system 1208. The lighting system 1200 of FIG. 8 may be incorporated in various rooms in a home. As illustrated, the system 1200 includes a room A 1202, a room B 1204, and a room C 1206. Although three rooms are shown in FIG. 8, the system 1200 may be implemented in any number and variety of rooms within a home, dwelling, or other environment.

The lighting controller system 1208 may monitor and control additional embedded systems and components within the system 1200. In one embodiment, the room A 1202 and the room B 1204 each include a switch component 1214, 1218. The switch components 1214, 1218 may also include a secondary embedded system 1216, 1220. The secondary embedded systems 1216, 1220 may receive instructions from the lighting controller system 1208. The secondary embedded systems 1216, 1220 may then execute these instructions. The instructions may include powering on or powering off various light components 1210, 1212, 1222, and 1224. The instructions may also include dimming the brightness or increasing the brightness of the various light components 1210, 1212, 1222, and 1224. The instructions may further include arranging the brightness of the light components 1210, 1212, 1222, and 1224 in various patterns. The secondary embedded systems 1216, 1220 facilitate the lighting controller system 1208 to monitor and control each light component 1210, 1212, 1222, and 1224 located in the room A 1202 and the room B 1204.

The lighting controller system 1208 might also provide instructions directly to a light component 1226 that includes a secondary embedded system 1228 in the depicted room C 1206. The lighting controller system 1208 may instruct the secondary embedded system 1228 to power down or power up the individual light component 1226. Similarly, the instructions received from the lighting controller system 1208 may include dimming the brightness or increasing the brightness of the individual light component 1226.

The lighting controller system 1208 may also monitor and provide instructions directly to individual light components 1230 and 1232 within the system 1200. These instructions may include similar instructions as described previously.

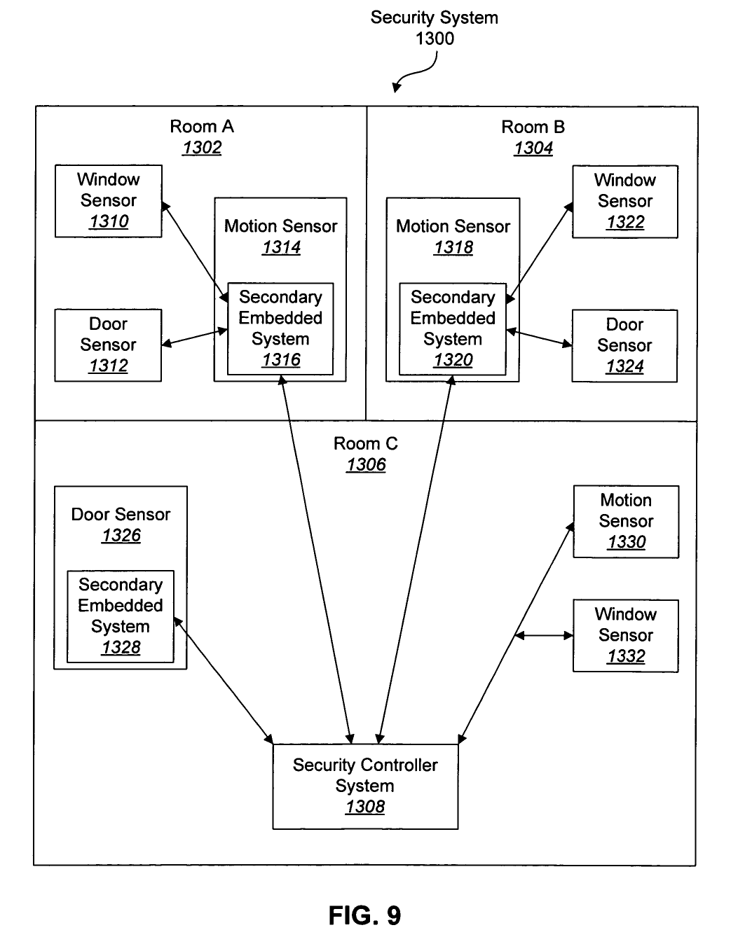

FIG. 9 is an additional embodiment of a system wherein the present systems and methods of the present invention may be implemented. FIG. 9 is a block diagram illustrating a security system 1300. The security system 1300 in the depicted embodiment is implemented in a room A 1302, a room B 1304, and a room C 1306. These rooms may be in the confines of a home or other enclosed environment. The system 1300 may also be implemented in an open environment where the rooms A, B and C, 1302, 1304, and 1306 respectively represent territories or boundaries.

The system 1300 includes a security controller system 1308. The security controller system 1308 monitors and receives information from the various components within the system 1300. For example, a motion sensor 1314, 1318 may include a secondary embedded system 1316, 1320. The motion sensors 1314, 1318 may monitor an immediate space for motion and alert the security controller system 1308 when motion is detected via the secondary embedded system 1316, 1320. The security controller system 1308 may also provide instructions to the various components within the system 1300. For example, the security controller system 1308 may provide instructions to the secondary embedded systems 1316, 1320 to power up or power down a window sensor 1310, 1322 and a door sensor 1312, 1324. In one embodiment, the secondary embedded systems 1316, 1320 notify the security controller system 1308 when the window sensors 1310, 1322 detect movement of a window. Similarly, the secondary embedded systems 1316, 1320 notify the security controller system 1308 when the door sensors 1312, 1324 detect movement of a door. The secondary embedded systems 1316, 1320 may instruct the motion sensors 1314, 1318 to activate the LED (not shown) located within the motion sensors 1314, 1318.

The security controller system 1308 may also monitor and provide instructions directly to individual components within the system 1300. For example, the security controller system 1308 may monitor and provide instructions to power up or power down to a motion sensor 1330 or a window sensor 1332. The security controller system 1308 may also instruct the motion sensor 1330 and the window sensor 1332 to activate the LED (not shown) or audio alert notifications within the sensors 1330 and 1332.

Each individual component comprising the system 1300 may also include a secondary embedded system. For example, FIG. 9 illustrates a door sensor 1326 including a secondary embedded system 1328. The security controller system 1308 may monitor and provide instructions to the secondary embedded system 1328 in a similar manner as previously described.

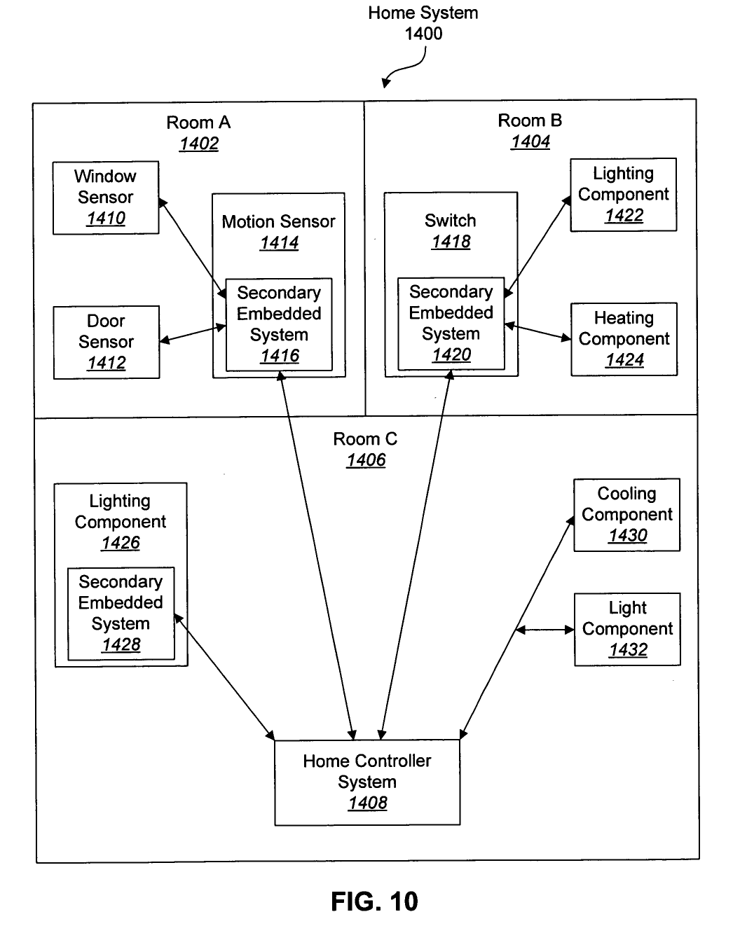

FIG. 10 is a block diagram illustrating one embodiment of a home system 1400. The home system 1400 includes a home controller 1408 that facilitates the monitoring of various systems such as the lighting system 1200, the security system 1300, and the like. The home system 1400 allows a user to control various components and systems through one or more embedded systems. In one embodiment, the home controller system 1408 monitors and provides information in the same manner as previously described in relation to FIGS. 8 and 9. In the depicted embodiment, the home controller 1408 provides instructions to a heating component 1424 via a secondary embedded system 1420. The heating component 1424 may include a furnace or other heating device typically found in resident locations or offices. The home controller system 1408 may provide instructions to power up or power down the heating component 1424 via the secondary embedded system 1420.

Similarly, the home controller 1408 may monitor and provide instructions directly to a component within the home system 1400 such as a cooling component 1430. The cooling component 1430 may include an air conditioner or other cooling device typically found in resident locations or offices. The central home controller 1408 may instruct the cooling component 1430 to power up or power down depending on the temperature reading collected by the central embedded system 1408. The home system 1400 functions in a similar manner as previously described in relation to FIGS. 8 and 9.

There are many types of embedded devices and many reasons for creating device networks. Several examples of device networking applications will be set forth. It will be appreciated by those skilled in the art that the examples discussed are not exhaustive.

One example of a device networking application is remote monitoring. Many useful device networks involve remote monitoring, the one-way transfer of information from one node to another. In these applications, providers typically act as small servers that report certain information in response to a requestor. Providers can also be set up to publish their state information to subscribers. A requestor may ask for periodic reports or for updates whenever the state changes, perhaps with some means of limiting how often updates are to be sent. Providers can be set up to notify requestors when some event or exceptional condition occurs.

Another example of a device network application is remote control, where requestors are able to send commands to providers to invoke some specific action. In most cases, remote control involves some sort of feedback.

A still further example of a device networking application is distributed control systems. The functions and data associated with individual providers can be combined and coordinated through a network to create a distributed system that provides additional value. Sometimes these distributed control systems can be established more or less automatically. In many cases, a more sophisticated device joins a peer-to-peer network to perform configuration, monitoring or diagnostic duties. Such systems may be created by objects that communicate as peers or through a master-slave configuration, in which each object in the system communicates with a single, central node that contains all of the control logic.

With each category of networking application, there are a variety of ways in which requesters may connect to providers. When a relatively small number of providers are involved, a requestor may use a web browser, pager or even a WAP-enabled cell phone to communicate with a provider in a more or less interactive manner. As the number of providers grows, however, these methods may become unworkable and requesters may employ more general data management techniques such as a spreadsheet or database application.

As a variety of networks are implemented over time and with different technologies, the situation can arise in which multiple networks might sit in the same home or facility, each using their own protocols and unable to communicate with the others. In this case the various networks and protocols can be bridged to create a single, larger network. This can allow a single application to access each provider, simplifying the interaction with all of the providers.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. An electrical outlet device comprising:
a power socket capable of receiving a plug;
a switch that is in electrical communication with a power supply wire such that as the switch is in a first position no power is available at the power socket, and when the switch is in a second position power is available at the power socket; and
a sensor that is capable of detecting a signal from the plug, wherein the plug includes a signal producing element, and wherein when the sensor detects the signal from the plug, the sensor causes the switch to be in the second position thereby providing power at the power socket, and such that when the sensor does, not detect the signal from the plug, the sensor causes the switch to be in the first position thereby providing no power at the power socket.

2. The electrical outlet device as defined in claim 1, wherein the sensor and the switch comprise a reed switch.

3. The electrical outlet device as defined in claim 1, wherein the sensor comprises an RFID reader.

4. The electrical outlet device as defined in claim 1, wherein the sensor comprises a mechanical sensor capable of detecting a physical element of the plug.

5. The electrical outlet device as defined in claim 4, wherein the mechanical sensor comprises a channel that mates with a finger of the plug.

6. An electrical plug comprising:
one or more contacts for connecting to a power socket; and
a signal producing element that produces a signal to be used in combination with an electrical outlet device having a switch and a sensor, wherein the sensor in the electrical outlet device is in electrical communication with the switch in the electrical outlet device such that when the sensor detects the signal from the plug, the sensor causes the switch to be in a second position thereby providing power at the power socket, and such that when the sensor does not detect the signal from the plug, the sensor causes the switch to be in a first position thereby providing no power at the power socket.

7. The electrical plug as defined in claim 6, wherein the signal producing element comprises a magnet to be used in combination with a reed switch in the electrical outlet device.

8. The electrical plug as defined in claim 6, wherein the signal producing element comprises an RFID tag to be used in combination with an RFID reader in the electrical outlet device.

9. An electrical plug adapter comprising:
one or more holes for receiving one or more contacts from a plug such that the contacts go through the holes with sufficient depth that the contacts may be inserted into a power socket of an electrical outlet device having a switch and a sensor; and
a signal producing element that produces a signal to be used in combination with the electrical outlet device, wherein the sensor in the electrical outlet device is in electrical communication with the switch in the electrical outlet device such that when the sensor detects the signal from the plug adapter, the sensor causes the switch to be in a second position thereby providing power at the power socket, and such that when the sensor does not detect the signal from the plug adapter, the sensor causes the switch to be in a first position thereby providing no power at the power socket.

10. The electrical plug adapter as defined in claim 9, wherein the signal producing element comprises a magnet to be used in combination with a reed switch in the electrical outlet device.

11. The electrical plug adapter as defined in claim 9, wherein the signal producing element comprises an RFID tag to be used in combination with an RFID reader in the electrical outlet device.

12. An electrical plug adapter comprising:
one or more holes for receiving an electrical plug to enable the electrical plug to be plugged into the electrical plug adapter;
one or more contacts that are configured to be inserted into a power socket of an electrical outlet device having a switch and a sensor; and
a signal producing element that produces a signal to be used in combination with the electrical outlet device, wherein the sensor in the electrical outlet device is in electrical communication with the switch in the electrical outlet device such that when the sensor detects the signal from the plug adapter, the sensor causes the switch to be in a second position thereby providing power at the power socket, and such that when the sensor does not detect the signal from the plug adapter, the sensor causes the switch to be in a first position thereby providing no power at the power socket.

13. The electrical plug adapter as defined in claim 12, wherein the signal producing element comprises a magnet to be used in combination with a reed switch in the electrical outlet device.

14. The electrical plug adapter as defined in claim 12, wherein the signal producing element comprises an RFID tag to be used in combination with an RFID reader in the electrical outlet device.
